(19) United States
(12) Patent Application Publication
(10) Pub. No.: US 2009/0144450 A1
(43) Pub. Date: Jun. 4, 2009

(54) SYNCHING MULTIPLE CONNECTED SYSTEMS ACCORDING TO BUSINESS POLICIES

(76) Inventors: W. Scott Kiester, Orem, UT (US); Mark J. Worwetz, Draper, UT (US); Karl E. Ford, Highland, UT (US)

Correspondence Address: KING & SCHICKLI, PLLC, 247 NORTH BROADWAY, LEXINGTON, KY, 40507, US

(21) Appl. No.: 11/946,971

(22) Filed: Nov. 29, 2007

(51) Int. Cl. G06F 15/16

(52) U.S. Cl. 709/248

(57) ABSTRACT

Apparatus and methods are described for synching data of multiple connected systems according to business policies utilized for common computing goals, such as identity management. A plurality of connectors interface with a corresponding one of the computing systems and have at least one object or attribute indicative of a status of an aspect of the common computing goals. A central connector interfaces with each of the connectors and encapsulates the entirety of business policies in a single location. It also monitors changes in the objects or attributes and, if detected, pushes data to a connector for pushing to its corresponding computing system. In this manner, data from all systems flows through the central connector and overcomes prior problems of business policies being located piecemeal in a variety of connectors, which may need swapping. Computer program products, computing systems, retrofits to existing software, to name a few, are other features.

### FIELD OF THE INVENTION

Generally, the present invention relates to computing environments arranged for common computing goals, such as identity management involving the distribution of identification cards to employees (e.g., personal identity verification (PIV) cards to Federal employees). Particularly, it relates to synching data of multiple connected systems in the environment according to business policies. Also, it relates to using a separate module for an entirety of complicated business logic, whereas previous approaches would piecemeal logic into multiple individual modules causing inflexibility and maintenance concerns. Various features relate to leveraging existing configurations by way of retrofits, computer program products and computing network interaction.

### BACKGROUND OF THE INVENTION

As is known, when business policies/logic touch many computing systems, it can be difficult to implement and maintain. This teaching provides a way to easily encapsulate and manage business policies that must be followed when synchronizing data between several connected systems arranged for a common computing goal.

In the context of identity management as a common computing goal, Homeland Security Presidential Directive 12 (HSPD-12) mandates establishment of an identification program for Federal Government employees. Among other things, it is to provide credential-controlled physical and logical access to facilities and information systems. A personal identity verification (PIV) card will be used to gain access, and such will comport with Federal Information Processing Standards (FIPS) promulgated by the Department of Commerce and the National Institute of Standards and Technology (NIST).

The GSA's Federal Acquisition Service also has launched programs providing assistance to Federal agencies, commissions, boards, organizations, militaries, etc. (hereafter collectively agencies), in producing compliant PIV cards. At a high level, they follow the four-steps of sponsorship, enrollment (including biometric identity information), adjudication and activation. In more detail, the steps include:

Sponsorship: An authorized federal employee (sponsor), per a given agency, submits a request for a PIV card on behalf of an applicant. The sponsor basically provides baseline identity information about the applicant, e.g., name, address, phone number, education, etc.

Enrollment: A designated registrar captures the baseline identity information, breeder documents and biometric identity information. Among the biometric identity information, the registrar collects fingerprints and takes a photograph of the applicant. Depending upon job level, they may also administer and/or collect toxicology reports (blood and/or urine test), DNA samples, retina scans or the like. The registrar also enters physical attributes (e.g., height, weight, hair color, eye color, blood type, etc.). Once collected, the biometric identity information is submitted to an Integrated Database Management System (IDMS) for storage. Three types of enrollment consist of: enrolling a never-before enrolled applicant; re-enrolling an applicant for issuance of a new PIV card after theft, loss, defect, etc.; and re-enrolling based on status change (i.e., change of agency or affiliation).

Adjudication (Inherently a Federal Government function): The applicant undergoes a background check, such as an FBI check and a NACI, and such is based upon, in whole or part, the collected enrollment information.

Activation: Upon successful adjudication, the applicant appears in person to receive their PIV card and is verified, such as by biometric authentication, e.g., optical scan, fingerprint match, etc. Second, various computing keys and certificates are generated and loaded on the card, such as placing an X.509 certificate on a PIV card, thereby provisioning the user to logical and physical access systems of the agency. After activation, the cards are ready for use.

Also, it presently exists that certain software products are available in the marketplace for use in implementing one or more of the foregoing steps. One particular product is the Identity Assurance Solution (IAS) software offering, provided by Novell, Inc. (the assignee of this invention). In general, an Identity Manager (IDM) integrates logical security of a site based on Identity Smart Cards and Physical site management. The logical portion of IDM associates users to agencies and organizations using the physical and logical infrastructures and resources.

While the IDM provides a great solution to synchronize data between systems according to business policy, it presently exists that business policies have been implemented per individual modules that interface with existing computing systems, such as a bio-enrollment system, a smart card management system, etc. In turn, the solution works well when a business policy only touches one or two systems, but does not scale well when several external systems are involved. Also, in the context of FIPS201, many complicated business policies are needed to be implemented.

Accordingly, there is need in the art of computing systems employing business policies/logic, such as identity management systems, to commonly encapsulate the logic to greatly simplify connectors to external systems. The need also extends to “swapping out” modules without affecting the underlying implementation of business policies/logic. In that many computing configurations already have applications or services with complex business policies/logic, it is further desirable in the art to leverage existing configurations by way of retrofit technology, thereby avoiding the costs of providing wholly new products. Taking advantage of existing frameworks, such as the IAS software offering by Novell, Inc, is another feature in optimizing existing resources. Any improvements along such lines should further contemplate good engineering practices, such as relative inexpensiveness, stability, ease of implementation, security, maintenance, flexibility, etc.

### SUMMARY OF THE INVENTION

The foregoing and other problems become solved by applying the principles and teachings associated with the hereinafter-described synching multiple connected systems according to business policies. At a high level, methods and apparatus are described that use a separate module to handle an entirety of complicated business logic, whereas previous approaches would embed pieces of business logic into individual modules, which caused inflexibility and maintenance issues.

In one existing identity management system, Identity Manager (IDM) provided a mechanism to synchronize data between systems according to business policy. However, it implemented business policies directly in each IDM driver that connected to each external system. While this works well when a business policy only touches one or two systems, it does not scale well when several systems are involved. Thus, embodiments of the invention now encapsulate the business policies in a single location to greatly simplify the other connectors interfaced with external computing systems. This also makes it easy to swap out external computing systems or connectors without affecting the underlying business policies.

In a representative embodiment, apparatus and methods are described for synching data of multiple connected systems according to business policies employed for common computing goals, such as identity management. A plurality of connectors interface with a corresponding one of the computing systems and have at least one object or attribute indicative of a status of an aspect of the common computing goals. A central connector interfaces with each of the connectors and encapsulates the entirety of business policies in a single location. It also monitors changes in the objects or attributes and, if detected, pushes data to a connector for pushing to its corresponding computing system. In this manner, data from all systems flows through the central connector and overcomes prior problems of business policies being located piecemeal in a variety of connectors, which may need swapping. Computer program products, computing systems, identity managers, retrofits to existing software, to name a few, are other features.

In a computing system embodiment, the invention may be practiced with a plurality of computing systems arranged together for a common computing goal; a plurality of policies retrievably stored for applying to the plurality of computing systems to accomplish the common computing goal, a plurality of connectors having executable code for installation on at least one computing device, wherein each of the connectors are interfaced with a corresponding one of the computing systems and having objects or attributes indicative of a status of an aspect of the common computing goal, and a central connector interfaced with the connectors. The plurality of policies, retrievably stored, are directly accessible by the central connector but not the each of the connectors, and the central connector is configured to monitor for a change in the objects or attributes. If the change is detected, the central connector pushes data to one connector for pushing to the corresponding one of the computing systems.

Computer program products are also disclosed. For instance, a product available as a download or on a computer readable medium has components to undertake some or all of the foregoing notions of the computing system environment. They are also available for installation on one or more physical or virtual computing devices.

The IAS software architecture is also exploited as part of the invention to leverage existing resources.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for synching multiple connected systems according to business policies; and

FIGS. 2 and 3 are combined diagrammatic views and flow charts of representative examples of synching multiple connected systems according to business policies.

### DETAILED DESCRIPTION OF THE ILLUSTRATED EMBODIMENTS

In the following detailed description of the illustrated embodiments, reference is made to the accompanying drawings that form a part hereof and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for synching multiple connected systems according to business policies are hereinafter described.

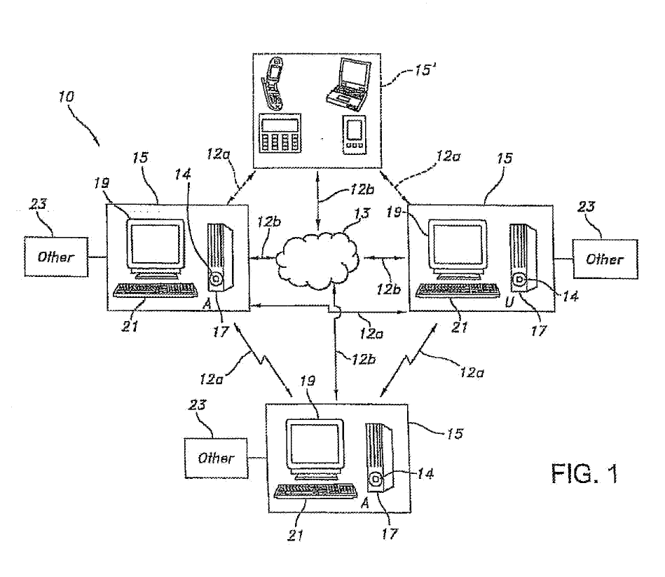

With reference to FIG. 1, a representative computing environment 10 for practicing the invention includes one or more computing devices 15 or 15′, per a central connector, other connectors or computing systems alike, arranged as individual or networked physical or virtual machines, including clients or hosts arranged with a variety of other networks and computing devices. In a traditional sense, an exemplary computing device typifies a server 17, such as a grid or blade server. Alternatively, it includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX, and LINUX, to name a few, a memory, and a bus that couples various internal and external units, e.g., other 23, to one another. Representative other items 23 include, but are not limited to, PDA's, cameras, scanners, printers, microphones joysticks, game pads, satellite dishes, hand-held devices, consumer electronics, minicomputers, computer clusters, main frame computers, a message queue, a peer machine, a broadcast antenna, a web server, an AJAX client, a grid-computing node, a peer, a virtual machine, a web service endpoint, a cellular phone, or the like. The other items may also be stand alone computing devices 15′ in the environment 10 or the computing device itself.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computing device 17. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download or any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1-T3 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

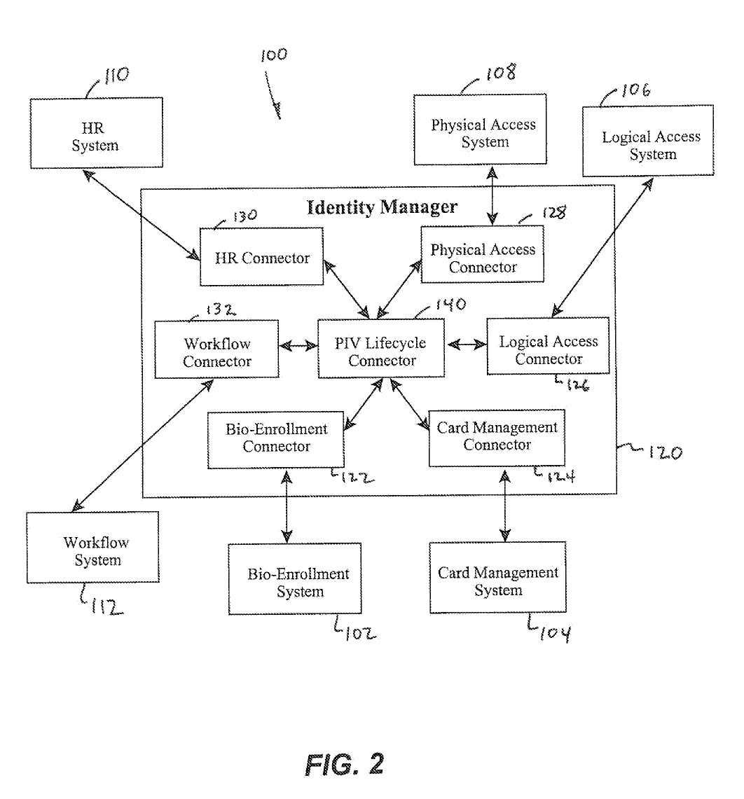

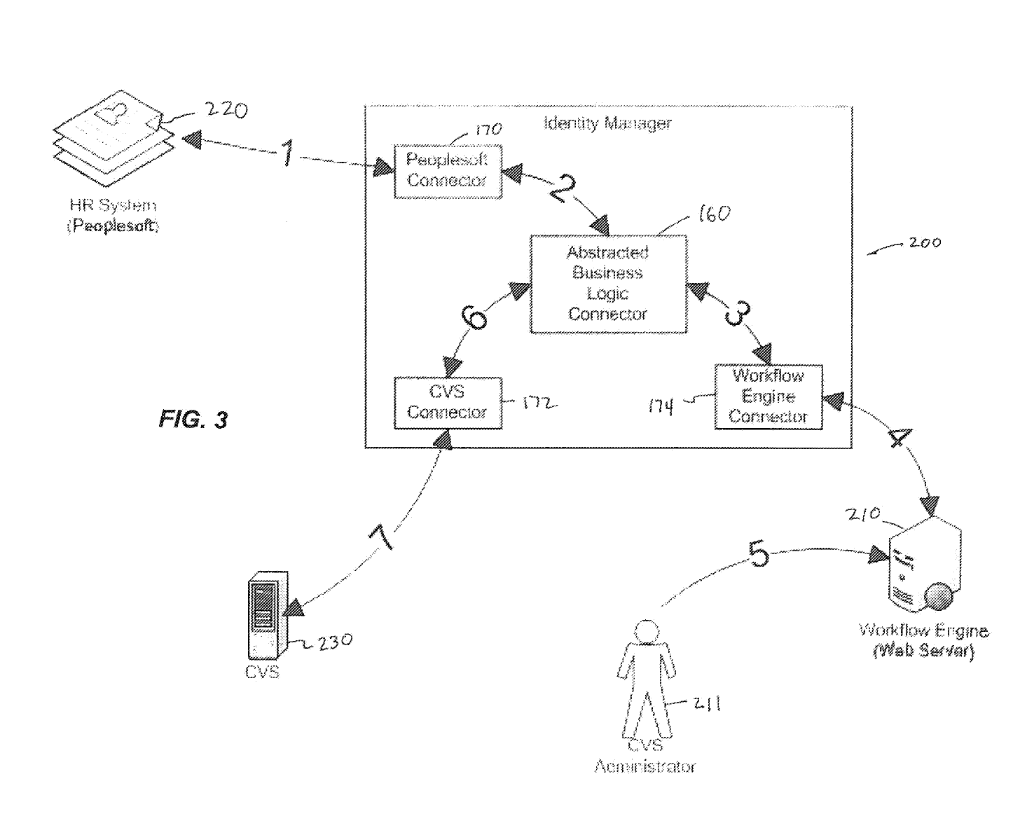

With the foregoing exemplary computing environment as back-drop, a representative embodiment of the invention was originally intended as a feature of the existing IAS software offering, contemplative of several components needing connection to accomplish the earlier-described GSA provisioning program. Furthermore, FIPS-201 specifies a set of very complex business policies that must be implemented across all the connected systems to satisfy strict standards regarding PIV cards. With reference to FIG. 2, the process of the present invention is given generically as 100 and may be implemented in whole or part as executable instructions in the computing environment of FIG. 1, including or not as a retrofit to the existing IAS software offering by Novell, Inc.

### EXAMPLE 1

IAS connects the following systems:
Biometric Enrollment System, 102: A system, for example, that collects a user's fingerprints, photograph, signature, scans the user's driver's license and/or passport, and performs background checks on the user. The system performs the necessary functions for the (GSA's enrollment, described in the background section, and incorporated as part of the invention.
Card Management System (CMS), 104: A system that prints, encodes, and activates smart cards, for instance. The system performs at least some of the necessary functions for the GSA's activation, described in the background section, and incorporated as part of the invention.
Logical Access Control System (LACS), 106: A system that controls access to computer systems and network resources, such as those of FIG. 1.
Physical Access Control System (PACS) 108: A system that controls access to a site or facility, (e.g., the system that controls the door readers on a building.)
HR System, 110: The system which, among other things, initially provisions all user accounts. The system performs the necessary functions for the GSA's sponsorship, described in the background section, and incorporated as part of the invention.
Workflow System, 112: A system that provides a mechanism for users to start a FIPS-201 defined process, or provide approval for a required approval step in the process.

IAS interfaces with and connects each of these systems using an identity manager (IDM) 120, including: 1) a plurality of connectors 122, 124, 126, 128, 130 and 132 that interface directly with a corresponding system; and 2) a central connector 140, labeled in this instance as a PIV Lifecycle connector. During use, data from all systems flows through the PIV Lifecycle Connector, which also contains an entirety of the FIPS 201 business logic.

In more detail, the following steps represent execution of the GSA's provisioning process during a smart card issuance in IAS version 3.0. Skilled artisans should notice the communication between each of the connectors and how much business policy/logic (often used interchangeably herein) is encapsulated in the PIV Lifecycle driver. The steps also serve to highlight the implementation of complex business policies across several connected systems, regardless of the computing goal.

Preliminarily, each connector (122-132) includes at least one object or attribute indicative of a status of an aspect of the common computing goal (in this case, identity management). A change in the object or attribute, monitored by the central connector, means an altered status in the environment. Depending upon the logic, it often causes the central connector to push data to one of the connectors, for pushing to its corresponding computing system, to ultimately accomplish the computing goal of issuing a user a smart card. As a result, data from all systems flows through the central connector and overcomes prior problems of business policies being located piecemeal in a variety of connectors, which may need swapping. Particular examples of attributes per one or more connectors are: fipsBioStatus, fipsCMSStatus, fipsPACSStatus, etc.

1. The HR system 110 adds a newly hired person during sponsorship. The HR connector 130 adds a newly hired user to the Identity Vault (not shown). The “user add” event triggers the PIV Lifecycle connector 140.

2. The PIV Lifecycle connector detects the user add event. The connector ensures that the user has the full set of attributes required for PIV card issuance (first name, last name, job title, etc.). The PIV Lifecycle connector then triggers the Bio-Enrollment connector 122 by setting the user's fipsBioStatus attribute to “Biometric Enrollment Ready.”

3. The Bio-Enrollment connector provisions the user in the Bio-Enrollment System 102, and sets fipsBioStatus to “Biometric Enrollment Complete.”

4. The PIV Lifecycle connector detects this changed status and sends an email to the user asking the user to schedule an appointment for Biometric Enrollment.

5. The user shows up for Biometric Enrollment, whereby the Bio-Enrollment system 102 captures the user's fingerprints, photograph, and a copy of the user's driver's license, etc. This data is sent to the Bio-Enrollment connector 122.

6. The Bio-Enrollment connector sets the user's fipsBioStatus attribute to Bio-Enrollment Complete, which triggers the PIV Lifecycle connector.

7. The PIV Lifecycle connector starts the GSA adjudication process. A workflow adjudication task is assigned to a designated adjudicator in the organization. An email is also sent to this individual notifying him/her of the adjudication task.

8. The adjudicator logs into the workflow system 112 (e.g., a web application on a display, FIG. 1), and is presented with a form that contains all of the user's personal information. The adjudicator indicates that they want the system to perform an AFIS (Automated Fingerprint identification Check). The workflow connector 132 sets the user's fipsWFStatus attribute to “Workflow Adjudication Complete,” which triggers the PIV Lifecycle connector.

9. The PIV Lifecycle connector triggers the Bio-Enrollment connector to perform the AFIS check by setting the user's fipsBioStatus attribute to “AFIS Check Ready.”

10. The Bio-Enrollment connector sends a message to the Bio-Enrollment system 102 asking it to perform an AFIS check for the user. The Bio-Enrollment system sends the user's fingerprints and personal information to an automated system at the FBI.

11. When a result is received from the FBI's AFIS system, the Bio-Enrollment system forwards it to the Bio-Enrollment connector. The Bio-Enrollment connector triggers the PIV Lifecycle connector 140 by setting the fipsBioStatus to “AFIS Check Complete.”

12. The PIV Lifecycle connector triggers the Card Management System (CMS) connector 124 by setting the attribute fipsCMSStatus to “CMS User Provisioning Ready.”

13. The CMS connector provisions the user in the CMS system 104. The CMS system sends the user's personal information to a card production facility, where a smart card is pre-printed and pre-encoded with the user's data.

14. When the user's card arrives at the CMS system, the CMS connector 124 triggers the PIV Lifecycle connector by setting the attribute fipsCMSStatus to “CMS Card Issuance Ready.”

15. The PIV Lifecycle connector sends the user an email, indicating that the user's card is ready for activation.

16. The user shows up for card activation. Certificates (i.e., X.509) are issued to the user and written to the card. The CMS diver stores a copy of these certificates on the user object in the Identity Vault, and triggers the PIV Lifecycle connector by setting fipsCMSStatus to “CMS Card Activation Complete.”

17. The PI Lifecycle connector triggers the Physical Access Control System (PACS) connector 128 by setting attribute fipsPACSStatus to “PACS Activation Ready.”

18. The PACS connector provisions the user in the PACS system 108. The user may now use his newly issued card to access the customer's site.

As is seen, there are large amounts of business logic embedded in the PIV Lifecycle connector, and all data flows therein. In turn, the PIV Lifecycle connector provides at least the following advantages:
1) Flexibility: Any of the individual connectors in the system could be swapped out without impacting any other part of the system. (For example, IAS currently uses ActivIdentity's Card Management System (CMS). If CMS were to be supported from another vendor, a CMS connector for the new vendor could be added without changing anything else. To the extent no PIV Lifecycle connector existed, it would be the situation that numerous different configurations for the Bio-Enrollment and PACS connectors would need to be maintained to support a new CMS); and
2) Maintainability: Customers can make changes to business policies in the PIV Lifecycle connector without impacting the other six drivers, where business policies/logic are not maintained.

### EXAMPLE 2

Again, the purpose of the IAS software offering is to issue and manage user credentials (X.509 certificates stored on smart cards) throughout their life cycle. However, there are other possible embodiments that have little or nothing to do with the (identity) management of authentication credentials.

For instance, a central connector 160, generically given as an “Abstracted Business Logic Connector” (ABL Connector) resides in a computing environment 200 for accomplishing the computing goal of synching a corporate directory 210, an HR (human resource) system 220, and a source code control system 230. It is assumed that the corporate directory is an Active Directory, the HR system is Peoplesoft, and the source code control system is CVS. As in the previous example, a primary purpose of the central connector is to provide a single place where business policies that affect multiple connectors can be maintained. (E.g., The business policies in the ABL Connector are abstracted from the rest of the connectors 170, 172, 174 in the system. This results in the ability to put all of the complicated logic employed by multiple connectors in one place and make for a more easily maintainable and flexible system).

1. When an individual is hired, an employee record is created in Peoplesoft. This record contains basic information about the individual, along with his job title. The Identity Manager Peoplesoft Connector 170 detects the new record in the HR system and automatically creates a new account in eDirectory for the user, including an attribute of the user regarding their job title. For the purposes of Example 2, the user's name is Inventor, and his title is “Software Engineer.”

2. The ABL Connector 160 detects the user add event and notices that the user's job title is “Software Engineer.” Knowing, by way of accessible business policy which states that all users with a title of “Software Engineer” need a CVS account, pending CVS administrator approval, the approval is to be obtained using a web-based approval tool (i.e., the Identity Manager User Application for Provisioning).

3. The ABL Connector 160 triggers the Workflow Engine Connector 174 so that the Workflow Engine 210 can get the required approval (of CVS administrator 211).

4. The Workflow Engine Connector sends a message to the Workflow Engine. This message includes the user's name, job title, and user ID. It also contains the CVS administrators user ID. The workflow engine sends an email to the CVS administrator 211, indicating that he has a new approval task.

5. The CVS administrator logs into the workflow engine 210 using his web browser. He sees a new approval task, where he must approve CVS access for Inventor. The CVS administrator indicates his approval by clicking a check box and submitting an approval form through his web browser. The work-flow engine sets an attribute on Inventor's user object indicating that he has been approved for CVS access.

6. The ABL Connector is triggered when the CVS approval attribute was set on Inventor's user object. The ABL Connector triggers the CVS Connector 172 so that a new CVS account can be created for Inventor.

7. The CVS Connector creates the new account in CVS 230.

As stated above, one advantage to this approach is flexibility. Also, the usage of separate module to handle all of the complicated business logic in al identity management system overcomes stated problems of embedded pieces of this logic into individual modules, which made the system less flexible and harder to maintain.

In extensions to the invention, the foregoing could be applied to complex configurations of any Identity Management System, or other system that synchronizes data according to business rules.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment, a method of synching multiple connected computing systems arranged together for a common computing goal, comprising:
acquiring a plurality of policies for applying to the multiple connected computing systems to achieve the common computing goal, the policies being retrievably stored;
providing a plurality of connectors having executable code, each of the connectors for interfacing with a corresponding one of the multiple connected computing systems, the each of the connectors having at least one object or attribute indicative of a status of an aspect of the common computing goal per the corresponding one of the multiple connected computing systems;
providing a central connector having executable code for interfacing with the each of the connectors, the retrievably stored policies being accessible by the central connector; and
configuring the central connector to monitor for a change in the at least one object or attribute of the each of the connectors indicating an altered status of the aspect of the common computing goal.

2. The method of claim 1, further including the central connector directing one of the plurality of connectors to communicate with the corresponding one of the multiple connected computing systems regarding the aspect of the common computing goal upon the central connector detecting the change in the at least one object or attribute of the one of the plurality of connectors.

3. The method of claim 1, further including providing an identity manager shell for the central connector and the plurality of connectors.

4. The method of claim 1, wherein the altered status of the aspect of the common computing goal is further detected by one of the plurality of connectors.

5. The method of claim 1, wherein the monitoring for the change in the at least one object or attribute further includes informing the central directory of the altered status by an eDirectory.

6. The method of claim 1, wherein the common computing goal is issuing and managing user credentials.

7. The method of claim 1, her including configuring the central connector to push data to one of the plurality of connectors for pushing to the corresponding one of the multiple connected computing systems upon the central connector detecting the change in the at least one object or attribute.

8. The method of claim 1, wherein the providing the central connector having executable code for interfacing with the each of the connectors further includes retrofitting an Identity Assurance Solution software program product.

9. In a computing system environment, a method of synching data of multiple connected computing systems arranged together for a common computing goal, comprising:
acquiring a plurality of policies for applying to the multiple connected computing systems to achieve the common computing goal, the policies being retrievably stored;
providing a plurality of connectors having executable code, each of the connectors for interfacing with a corresponding one of the multiple connected computing systems, the each of the connectors having at least one object or attribute indicative of a status of an aspect of the common computing goal per the corresponding one of the multiple connected computing systems;
providing a central connector having executable code for interfacing directly with the each of the connectors but not the multiple connected computing systems, the retrievably stored policies being accessible by the central connector but not the each of the connectors;
by the central connector, monitoring for a change in the at least one object or attribute of the each of the connectors indicating an altered status of the aspect of the common computing goal, and
by the central connector, pushing data to one of the plurality of connectors for pushing to the corresponding one of the multiple connected computing systems upon the central connector detecting the change in the at least one object or attribute.

10. The method of claim 9, further including swapping one of the multiple connected computing systems with another computing system.

11. The method of claim 10, further including swapping a corresponding one of the plurality of connectors upon the swapping the one of the multiple connected computing systems.

12. The method of claim 11, wherein the central connector interfaces with the swapped said corresponding one of the plurality of connectors without requiring a change to the retrievably stored policies.

13. In a computing system environment, a method of synching multiple connected systems arranged together for a common computing goal of identity management, comprising:
providing a plurality of computing systems to enroll users in an identity management program;
defining a plurality of policies for applying to the plurality of computing systems for enrolling the users in the identity management program;
providing an identity manager, including providing a plurality of connectors and a central connector with executable code, wherein each of the connectors interface with a corresponding one of the computing systems, the each of the connectors having at least one object or attribute indicative of a status of an aspect of identity management per the corresponding one of the computing systems, and wherein the central connector interfaces with the each of the connectors, the plurality of policies being directly accessible by the central connector but not the each of the connectors;
by the central connector, monitoring for a change in the at least one object or attribute of the each of the connectors indicating an altered status of the aspect of identity management; and
by the central connector, pushing data to one of the plurality of connectors for pushing to the corresponding one of the computing systems upon the central connector detecting the change in the at least one object or attribute.

14. A computing system environment, comprising:
a plurality of computing systems arranged together for accomplishing a common computing goal;
a plurality of policies retrievably stored for applying to the plurality of computing systems to accomplish the common computing goal;
a plurality of connectors having executable code for installation on at least one computing device, wherein each of the connectors are interfaced with a corresponding one of the computing systems, the each of the connectors having at least one object or attribute indicative of a status of an aspect of the common computing goal per the corresponding one of the computing systems, and
a central connector having executable code for installation on a computing device the same or different as the at least one computing device, the central connector interfaced with the each of the connectors, the plurality of policies retrievably stored being directly accessible by the central connector but not the each of the connectors, wherein the central connector is configured to monitor for a change in the at least one object or attribute of the each of the connectors indicating an altered status of the common computing goal and, if the change is detected, being configured to push data to one of the plurality of connectors for pushing to the corresponding one of the computing systems.

15. The system of claim 14, further including an identity manager for the each of the plurality of connectors and the central connector, the common computing goal being a user identity management program.

16. The system of claim 14, wherein the central connector does not interface directly with any of the plurality of computing systems.

17. A computer program product available as a download or on a computer readable medium having executable instructions for installation on one or more computing devices in a computing environment for synching data to accomplish a computing goal common in the computing environment, comprising:
a first component to retrieve a plurality of policies applicable to accomplishing the computing goal;
a second component for interfacing a plurality of connectors with a corresponding computing system, each of the connectors having at least one object or attribute indicative of a status of an aspect of the computing goal per the corresponding one of the computing systems; and
a third component for interfacing a central connector with the each of the connectors, the central connector but not the each of the connectors being able to access the policies, wherein the central connector is configured to monitor for a change in the at least one object or attribute of the each of the connectors indicating an altered status of the computing goal.

18. The computer program product of claim 17, wherein if the change is detected by the central connector, the central connector being configured to push data to one of the plurality of connectors for pushing to the corresponding one of the computing systems.

19. The computer program product of claim 17, further including an identity manager component for the central connector and the plurality of connectors.

20. The computer program product of claim 17, further including an eDirectory component.
